(19) United States
(12) Patent Application Publication
(10) Pub. No.: US 2008/0043297 A1
(43) Pub. Date: Feb. 21, 2008

(54) Adecorative and indicative light-emitting apparatus embedded in object and control method thereof

(75) Inventors: Ming-Horng Shiu, Tongsiao Township (TW); Hsin Hung Lee, Fongshan City (TW); Hsu-Hung Chen, Sanchong City (TW)

Correspondence Address: THE LAW OFFICES OF ANDREW D. FORTNEY, PH.D., P.C., 401 W FALLBROOK AVE STE 204, FRESNO, CA, 93711-5835, US

(73) Assignee: Quanta Computer Inc.

(21) Appl. No.: 11/657,226

(22) Filed: Jan. 23, 2007

(30) Foreign Application Priority Data
Aug. 16, 2006 (TW) 095130025

(51) Int. Cl. H04N 1/46

(52) U.S. Cl. 358/509

(57) ABSTRACT

The invention provides a decorative and indicative light-emitting apparatus embedded in an object. The light-emitting apparatus, according to the invention, includes a light-emitting device, a light-sensing module and a processing/controlling module. The light-emitting device is disposed on the object. The light-sensing module, disposed on the object, is used for sensing an ambient light and analyzing the color of the ambient light. The processing/controlling module, electrically coupled to the light-emitting device and the light sensing module, respectively, is used for receiving the color of the ambient light from the light-sensing module, for defining a specific color in accordance with the color of the ambient light and a criterion, and for controlling the light-emitting device to emit a light with the specific color.

### BACKGROUND OF THE INVENTION

1. Field of the Invention

The present invention relates to a decorative and indicative light-emitting apparatus and a control method thereof, and more in particular, to a light-emitting apparatus embedded in an object and a control method thereof.

2. Description of the Prior Art

As science and production advance, design considerations of products, ranging from different types of daily utensils to consumer electronic products, no longer solely emphasizes on upgrading the functionality of the products. Besides useful basic functions, consumers usually demand products to possess technology, fashion sense, and entertainment. According to the trend, the issue of how to enhance the aesthetic sense and implications to increase the added value of a product, so as to raise consumer desire to purchase and to use the product, is frequently contemplated by designers.

On the other hand, as the development of photo-electricity technology advances, producing colors of lights emitted by light-emitting devices (e.g., light-emitting diodes) is approaching completion; we can now constitute light of all wavelengths within the range of visible light. At the same time, elevation of light-emitting efficiency allows the application scope of the light-emitting devices to expand from the initial functions of communication and indication to lighting and decoration. Currently, many electronic products also use light-emitting devices as one of the design factors, wherein the light-emitting devices are mostly found in portable wireless communication devices (including mobile phones and personal digital assistants). In the applications of a light-emitting device in a wireless communication device, in addition to being used as a backlighting module in the display, it can be applied to the casing of the wireless communication device to emit lights with various colors to increase the fashion sense and the functionality of the wireless communication device.

The application of a light-emitting device described previously is mostly emission of light with fixed colors, or it is light emission, in accordance with user settings, according to the color and timing preferred by the user. The inventor of the present invention uses the concept of making a product object generate light with a color identical to or complementary to that of the ambient light to achieve the aim of decoration and indication; thus, the invention is made. It is hoped that by disclosing and applying the invention, design concepts of products can become more plentiful.

### SUMMARY OF THE INVENTION

A scope of the invention is to provide a decorative and indicative light-emitting apparatus embedded in an object. The decorative and indicative light-emitting apparatus can emit light by referencing the color of the ambient light sensed in the ambience of the object.

Another scope of the invention is to provide a control method for controlling the light-emitting device embedded in an object. The light-emitting device references the color of the ambient light sensed in the ambience of the object to emit light.

The decorative and indicative light-emitting apparatus, according to a preferred embodiment of the invention, includes a light-emitting device, a light-sensing module, and a processing/controlling module. The decorative and indicative light-emitting apparatus is embedded in an object, and the light-emitting device is disposed on the object. The light-sensing module, disposed on the object, is used for sensing an ambient light and for analyzing the color of the ambient light. The processing/controlling module, electrically coupled to the light-emitting device and the light-sensing module, respectively, is used for receiving the color of the ambient light from the light-sensing module and for defining, according to the color of the ambient light and a criterion, a specific color to further control the light-emitting device to emit light with the specific color.

In an embodiment of the invention, the decorative and indicative light-emitting module further includes a user interface. The user interface, coupled to the processing/controlling module, enables a user to edit the criterion, so that the light-emitting device references the color of the ambient light to emit light.

In an embodiment of the invention, the light-emitting device includes a red light-emitting diode, a green light-emitting diode, and a blue light-emitting diode. The processing/controlling module makes the light-emitting device emit light with a specific color by controlling the red light-emitting diode, the green light-emitting diode, and the blue light-emitting diode.

In one embodiment of the invention, the decorative and indicative light-emitting apparatus further includes a light-diffusing device. The light-diffusing device is disposed on the object. The light emitted by the light-emitting device first enters into the light-diffusing device and then diffuses to the outside of the object through the light-diffusing device.

The control method for controlling the decorative and indicative light-emitting apparatus, according to the preferred embodiment of the invention, is used for controlling the light-emitting device embedded in the object to emit light. The control method includes the following steps. First, the ambient light in the ambience of the object is detected. Next, the color of the ambient light is analyzed. Then, a specific color is defined in accordance with the color of the ambient light and a criterion. Finally, the light-emitting device is controlled to emit light with the specific color.

In one embodiment of the invention, in the steps for analyzing the color of the ambient light, the intensity of the ambient light is analyzed simultaneously. Then, the specific color and a specific intensity are defined according to the color, the intensity of the ambient light, and the criterion. Finally, the light-emitting device is controlled to emit light with the specific color and the specific light intensity.

The advantage and spirit of the invention may be understood by the following recitations together with the appended drawings.

### BRIEF DESCRIPTION OF THE APPENDED DRAWINGS

FIG. 1 is a system context schematic diagram of a decorative and indicative light-emitting apparatus according to a preferred embodiment of the invention.

FIG. 2 is an outside perspective view of the decorative and indicative light-emitting apparatus implemented in an object according to the invention.

FIG. 3 is an outside perspective view of the decorative and indicative light-emitting apparatus implemented in another object according to the invention.

FIG. 4 is a system context schematic diagram of the decorative and indicative light-emitting apparatus according to a preferred embodiment of the invention.

FIG. 5 is a flowchart of the control method of the decorative and indicative light-emitting apparatus according to the preferred embodiment of the invention.

### DETAILED DESCRIPTION OF THE INVENTION

The present invention provides a decorative and indicative light-emitting apparatus embedded in an object, and in particular, the decorative and indicative light-emitting apparatus can reference the color of the ambient light in the ambience of an object to control itself to emit light with a specific color.

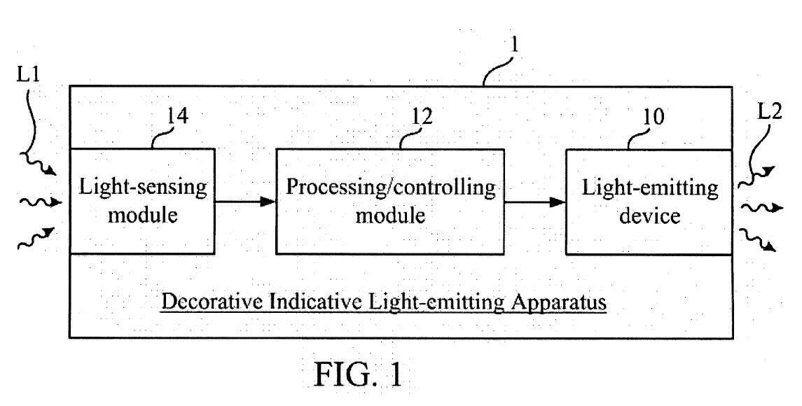

First, referring to FIG. 1, FIG. 1 is a system context schematic diagram of a decorative and indicative light-emitting apparatus 1 according to a preferred embodiment of the invention. The decorative and indicative light-emitting apparatus 1 is embedded in an object (not shown in FIG. 1). In FIG. 1, the decorative and indicative light-emitting apparatus 1 includes a light-emitting device 10, a processing/controlling module 12, and a light-sensing module 14. The light-emitting device 10 is disposed on the object. The light-sensing module 14, disposed on the object, is used for sensing the ambient light (L1), and for analyzing the color of the ambient light (L1). The processing/controlling module 12, electrically coupled to the light-emitting device 10 and the light-sensing module 14 respectively, is used for receiving the color of the ambient light (L1) from the light-sensing module 14 and for defining, according to the color of the ambient light (L1) and a criterion, a specific color to further control the light-emitting device 10 to emit a light (L2) with the specific color.

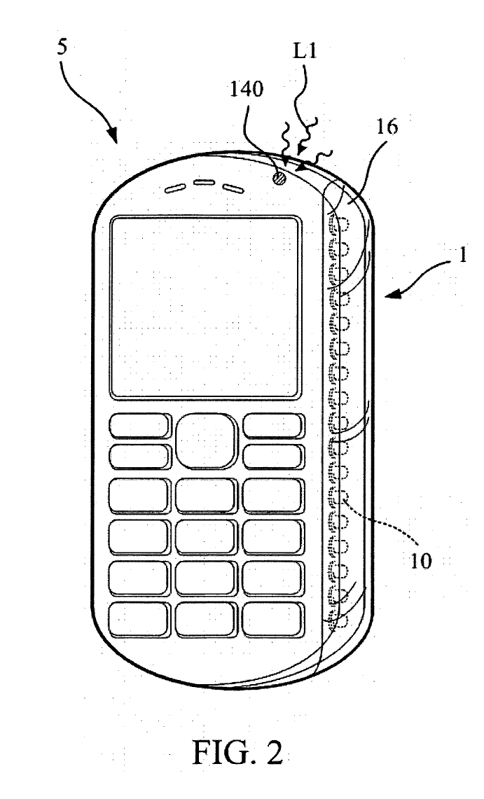

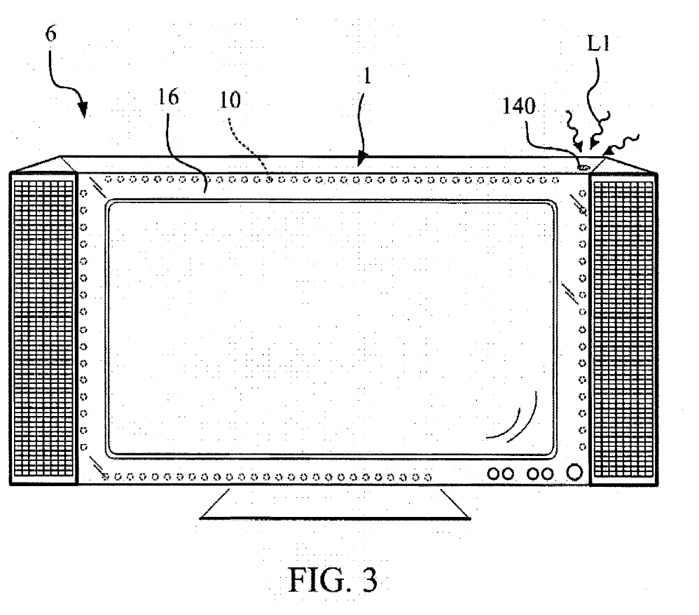

Then, referring to FIG. 2 and FIG. 3, FIG. 2 is an outside perspective view of the decorative and indicative light-emitting apparatus 1 implemented in an object 5 according to the invention. FIG. 3 is an outside perspective view of the decorative and indicative light-emitting apparatus 1 implemented in an object 6 according to the invention. The object 5 in FIG. 2 is a portable wireless communication apparatus, and the decorative and indicative light-emitting apparatus 1 is embedded in the object 5. The object 6 in FIG. 3 is a video and audio display apparatus, and the decorative and indicative light-emitting apparatus 1 is embedded in the object 6.

In FIG. 2 and FIG. 3, the decorative and indicative light-emitting apparatus 1 includes a light-diffusing device 16. The light-diffusing device 16, disposed on the object 5 and the object 6, is used for enlarging the light-emitting areas of the light-emitting device 10 on the object 5 and the object 6, so as to increase the visible range of the light-emitting device 10. The light generated by the light-emitting device 10 first enters into the light-diffusing device 16, and it is then emitted to the outside of the object 5 and the object 6 through the light-diffusing device 16. The light-diffusing device 16 described here can be a light-guiding plate, a light-guiding column, or an optical fiber, which is combined with the object after appropriate designs.

In addition to disclosing that the object 5 in FIG. 2 and the object 6 in FIG. 3 are a portable wireless communication apparatus and a video and audio display apparatus respectively, the decorative and indicative light-emitting apparatus 1, according to the invention, can be implemented in objects with any form or any function, such as a portable electronic apparatus (e.g. a personal digital assistant or a video/audio display apparatus), a stationary electronic equipment (e.g. a digital video disc playing system or an audio system), a furniture equipment (e.g. a table, a chair, or a cabinet), clothing, a shoe, a hat, an accessory, etc. Therefore, the object 5 in FIG. 2 and the object 6 in FIG. 3 are only two specifications, not specifications used for limiting the claim of the invention. In FIG. 2 and FIG. 3, the configured position of the light-emitting device 10 with respect to the object 5 and the object 6 are only two specifications, not specifications used for limiting the claim of the invention.

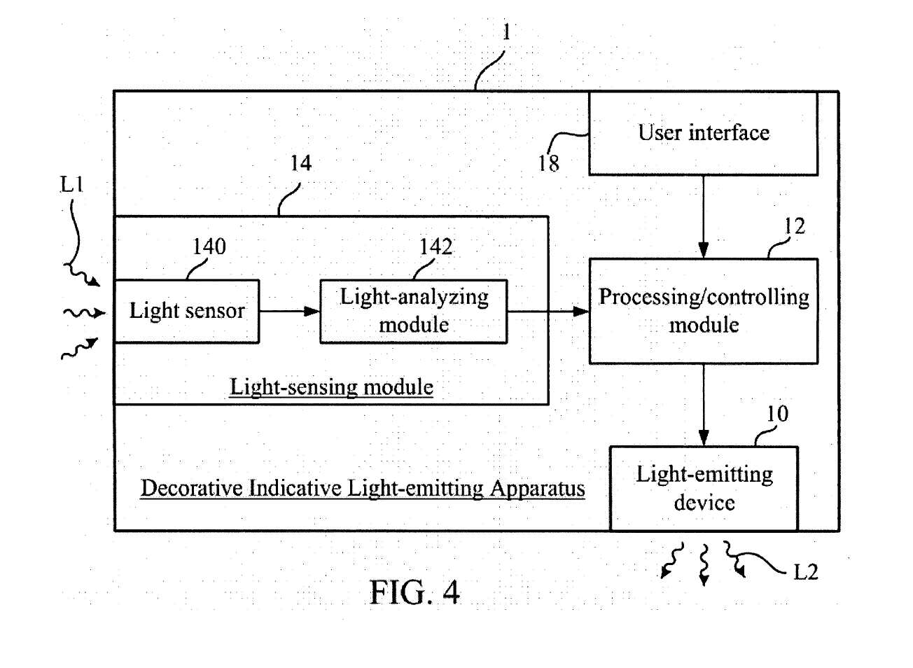

Referring to FIG. 4, FIG. 4 is a system context schematic diagram of the decorative and indicative light-emitting apparatus 1 according to a preferred embodiment of the invention. As shown in FIG. 4, the decorative and indicative light-emitting apparatus 1 further includes a user interface 18. The light-sensing module 14 includes a light sensor 140 and a light-analyzing module 142. The light sensor 140 is disposed on the object. Please refer to FIG. 2 and FIG. 3 at the same time. FIG. 2 and FIG. 3 show that the light sensor 140, disposed on the object 5 and the object 6, is used for receiving the ambient light (L1). The light sensor 140 immediately outputs a sensing signal after receiving the ambient light (L1). The light-analyzing module 142, eclectically coupled to the light sensor 140 and the processing/controlling module 12 respectively, is used for receiving the sensing signal outputted by the light sensor 140 to analyze the color of the ambient light (L1) and to output the result to the processing/controlling module 12.

The sensing signal outputted by the light sensor 140 described above is mostly in a form of an analog signal. After the light-analyzing module 142 receives the sensing signal, the light-analyzing module 142 performs analog to digital conversion. Then, by subsequent analyses, the optical properties of the ambient light (L1) are determined. The optical properties include the color and the intensity of the ambient light (L1). The optical sensing and the conversion described here are prior art; thus, they are not being further illustrated.

The user interface 18 in FIG. 4, electrically coupled to the processing/controlling module 12, enables a user to edit the criterion through the user interface 18 and to make the processing/controlling module 12 define, according to the color of the ambient light and the criterion, the specific color, so as to control the light-emitting device 10 to emit light with the specific color. To further explain, the decorative and indicative light-emitting apparatus 1, according to the invention, can sense the color of the ambient light (L1), and the user can control, according to the user's preference, the light-emitting device 10 to emit the light (L2) identical to the ambient light (L1) or the light (L2) complementary to the ambient light (L1). At the same time, the brightness, the intensity, and the timing of light emission can be further controlled.

In an embodiment of the invention, the light-emitting device 10 includes a red light-emitting diode, a green light-emitting diode, and a blue light-emitting diode. The processing/controlling module 12 can make the light-emitting device 10 generate light with the specific color by controlling the red, the green, and the blue light-emitting diodes.

Furthermore, in an embodiment of the invention, the decorative and indicative light-emitting apparatus 1 can reference the intensity of the ambient light (L1) to emit the light (L2). The light-sensing module 14 can analyze the color and the intensity of the ambient light (L1) simultaneously and can output the result to the processing/controlling module 12. The processing/controlling module 12 then defines, according to the color and the intensity of the ambient light (L1) and the criterion, the specific color and the specific intensity, so as to further control the light-emitting device 10 to emit light with the specific color and the specific intensity.

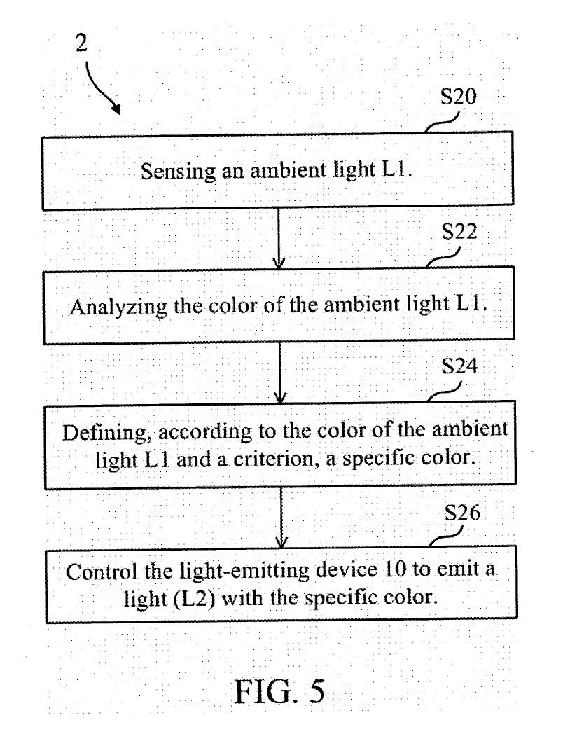

Then, referring to FIG. 5, FIG. 5 is a flowchart of the control method 2 of the decorative and indicative light-emitting apparatus 1 according to the preferred embodiment of the invention. The control method 2 is used for controlling the light-emitting device 10 embedded in an object to emit light. Please refer to FIG. 1 and FIG. 4 at the same time for other relevant system context and device. The control method 2 includes the following steps:

First, the light sensor 140 of the light-sensing module 14 senses the ambient light (L1) in the ambience of the object (step S20).

Then, the light-analyzing module 142 of the light-sensing module 14 analyzes the color of the ambient light (L1) and output the result (step 22).

Next, the processing/controlling module 12 receives the color of the ambient light (L1), and defines, according to the color of the ambient light and a criterion defined by a user, a specific color (step S24).

Finally, the processing/controlling module 12 controls the light-emitting device 10 to emit a light (L2) with the specific color (step S26).

In an embodiment of the invention, in step S22, the light-analyzing module 142 of the light-sensing module 14 can analyze the intensity of the ambient light (L1) simultaneously. Then, in step S24, the processing/controlling module 12 receives the color and the intensity of the ambient light (L1) and the criterion set by the user and defines the specific color and a specific intensity. Finally, in the step S26, the processing/controlling module 12 controls the light-emitting device 10 to emit light with the specific color and the specific intensity.

By the detailed description of the embodiments according to the invention, it is clear that the decorative and indicative light-emitting apparatus 1, according to the invention, can control the light-emitting device 10 to reference the optical properties (including color) of the ambient light, so as to control the light-emitting device 10 to emit light with a specific color to achieve the functionality of decorating and/or indicating an object. The decorative and indicative light-emitting apparatus 1 can generate a light (L2) identical to the ambient light (L1) to make the object simulate the ambience to reach the effect of camouflage and becoming part of the ambience or to generate a light (L2) complementary to the ambient light (L1) to underscore the object and to achieve the effect of indicating the object.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A decorative and indicative light-emitting apparatus embedded in an object, said light-emitting apparatus comprising:
a light-emitting device, disposed on the object;
a light-sensing module, disposed on the object, for sensing an ambient light, and analyzing the color of the ambient light; and
a processing/controlling module, electrically coupled to the light-emitting device and the light-sensing module, respectively, for receiving the color of the ambient light from the light-sensing module, defining a specific color in accordance with the color of the ambient light and a criterion, and controlling the light-emitting device to emit a light with the specific color.

2. The light-emitting apparatus of claim 1, further comprising a light-diffusing device disposed on the object such that the light emitted by the light-emitting device enters into the light-diffusing device, and then diffuses to the outside of the object.

3. The light-emitting apparatus of claim 2, wherein the light-diffusing device comprises one selected from the group consisting of a light-guiding plate, a light-guiding column, and an optical fiber.

4. The light-emitting apparatus of claim 1, wherein the light-sensing module also analyzes the intensity of the ambient light, and the processing/controlling module also receives the intensity of the ambient light from the light-sensing module, defines a specific intensity in accordance with the intensity of the ambient light and the criterion, and controls the light-emitting device to emit the light with the specific color and the specific intensity.

5. The light-emitting apparatus of claim 1, wherein the light-emitting device comprises a red light-emitting diode, a blue light-emitting diode, and a green light-emitting diode.

6. The light-emitting apparatus of claim 1, further comprising a user interface, coupled to the processing/controlling module, for enabling a user to edit the criterion.

7. The light-emitting apparatus of claim 1, wherein the specific color is identical to the color of the ambient light.

8. The light-emitting apparatus of claim 1, wherein the specific color is complementary to the color of the ambient light.

9. The light-emitting apparatus of claim 1, wherein the object is a portable electronic device or a stationary electronic equipment.

10. The light-emitting apparatus of claim 1, wherein the light-sensing module comprises:
a light sensor, disposed on the object, for receiving the ambient light, and transmitting a sensing signal in accordance with the ambient light; and
a light-analyzing module, electrically coupled to the light sensor and the processing/controlling module, respectively, for receiving the sensing signal, and analyzing the color of the ambient light in accordance with the sensing signal.

11. A method for controlling a light-emitting device, embedded in an object, to emit a light, said method comprising the steps of:
(a) sensing an ambient light associated with the ambience of the object;
(b) analyzing the color of the ambient light;
(c) defining a specific color in accordance with the color of the ambient light and a criterion; and
(d) controlling the light-emitting device to emit a light with the specific color.

12. The method of claim 11, wherein in the step (b), the intensity of the ambient light is also analyzed, in the step (c), a specific intensity is also defined in accordance with the color and the intensity of the ambient light and the criterion, and in the step (d), the light-emitting device is controlled to emit the light with the specific color and the specific intensity.

13. The method of claim 11, wherein the light-emitting device comprises a red light-emitting diode, a blue light-emitting diode, and a green light-emitting diode.

14. The method of claim 11, wherein the specific color is identical to the color of the ambient light.

15. The method of claim 11, wherein the specific color is complementary to the color of the ambient light.
